(19) United States
(12) Patent Application Publication
(10) Pub. No.: US 2025/0251884 A1
(43) Pub. Date: Aug. 7, 2025

(54) SERVER SYSTEM, ERROR NOTIFICATION METHOD, AND NON-TRANSITORY COMPUTER-READABLE STORAGE MEDIUM

(71) Applicant: CANON KABUSHIKI KAISHA, Tokyo (JP)

(72) Inventor: NAOTO UTE, Tokyo (JP)

(21) Appl. No.: 19/043,605

(22) Filed: Feb. 3, 2025

(30) Foreign Application Priority Data
Feb. 7, 2024 (JP) 2024-017428

(51) Int. Cl. G06F 3/12

(52) U.S. Cl. CPC G06F 3/1234; G06F 3/1204; G06F 3/121; G06F 3/1267; G06F 3/1288

(57) ABSTRACT

A server system comprises at least one memory storing instructions; and at least one processor that is in communication with the at least one memory and that, when executing the instructions, cooperates with the at least one memory to execute processing. The processing includes controlling to render print data received from a terminal; storing print data generated by the rendering; and in a case where an error occurs in the rendering, notifying a terminal of the error.

### BACKGROUND OF THE INVENTION

### Field of the Invention

The present invention relates to a server system, an error notification method, and a non-transitory computer-readable storage medium in, for example, hold printing.

### Description of the Related Art

Conventionally, hold printing exists as one of printing methods of a multi-functional printing apparatus (MFP). In the hold printing, when print data is transmitted from a client terminal such as a personal computer (PC) to a print server, the print data is stored in the print server. After that, a user can select the print data held in the print server from the operation panel unit of the MFP and execute printing (see, for example, Japanese Patent Laid-Open No. 2018-118419).

In the hold printing, when the user performs a print execution operation on the MFP, a print management server performs rendering processing of converting the print data into a data format printable by the MFP and executes printing. Rendering indicates processing of performing adjustment of the resolution of a document or an image, adjustment of the page layout or arrangement of the document, and setting of the output format of a printed product, and converting print data into a data format such as PDF, JPEG, or TIFF, which is printable by an MFP. However, if the print data is corrupted or encrypted, rendering fails, and an error occurs. An error notification at this time is displayed on the panel of the MFP, and the user can confirm the error on the MFP. However, since the error is displayed after the print execution operation on the MFP, the user needs to return to the PC after the error display, correct the print data, and redo transmission processing.

In hold printing of Japanese Patent Laid-Open No. 2018-118419, however, an image forming apparatus analyzes the data of a print job received from a PC, and if an error occurs, an error message corresponding to the error is added to the bibliographic information of the print job. When the user then displays a print job list via the operation unit of the image forming apparatus, the error message can be displayed. In Japanese Patent Laid-Open No. 2018-118419, the print job list is displayed on the image forming apparatus, and in which page the error occurs is displayed. For this reason, the user can instruct to print up to the page immediately before the error. Even in the technique of Japanese Patent Laid-Open No. 2018-118419, however, since the error message is displayed on the operation unit of the image forming apparatus, concerning pages from the page of the error, the user needs to return to the PC, correct the print data, and redo the print job transmission processing. As described above, in the conventional hold printing, rework occurs at the time of error occurrence, resulting in an increase of the work load on the user and low productivity.

### SUMMARY OF THE INVENTION

The present invention quickens the time of error notification in hold printing and reduces a work load on a user.

An aspect of the present invention provides a server system comprising:
at least one memory storing instructions; and
at least one processor that is in communication with the at least one memory and that, when executing the instructions, cooperates with the at least one memory to execute processing, the processing including:
controlling to render print data received from a terminal;
storing print data generated by the rendering; and
in a case where an error occurs in the rendering, notifying a terminal of the error.

Further features of the present invention will become apparent from the following description of exemplary embodiments with reference to the attached drawings.

### BRIEF DESCRIPTION OF THE DRAWINGS

FIG. 1 is a view showing the configuration of a print system;

FIG. 2 is a block diagram showing the schematic configuration of an MFP 120;

FIG. 3 is a block diagram showing the schematic configuration of a client terminal 110, a print management server 140, and a data conversion server 150;

FIG. 4 is a sequence chart showing the procedure of processing of storing print data in the print management server 140;

FIG. 5 is a view showing a print setting screen displayed on the client terminal 110;

FIG. 6 is a view showing a print number display screen displayed on the client terminal 110;

FIG. 7 is a view showing an error notification screen displayed on the client terminal 110;

FIG. 8 is a view showing a print data generation screen displayed on the client terminal 110;

FIG. 9 is a sequence chart showing the procedure of processing of the MFP 120 executing printing of print data held in the print management server 140;

FIG. 10 is a view showing a print number input screen displayed on the MFP 120;

FIG. 11 is a sequence chart showing the procedure of processing of storing print data in a print management server 140 according to the second embodiment;

FIG. 12 is a view showing an error notification screen displayed on a client terminal 110;

FIG. 13 is a sequence chart showing the procedure of processing of the MFP 120 executing printing of print data held in a print management server 140 according to the second embodiment;

FIG. 14 is a sequence chart showing the procedure of processing of storing print data in a print management server 140 according to the third embodiment; and

FIG. 15 is a flowchart showing processing of performing rendering by a data conversion server 150.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### Overall Configuration

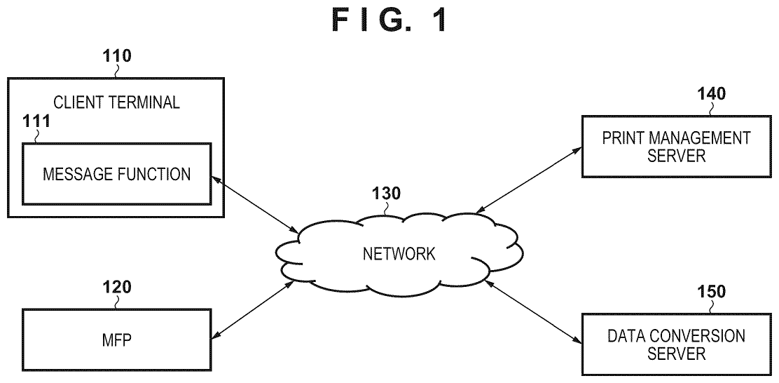

FIG. 1 is a view showing the overall configuration of a print system. The print system shown in FIG. 1 includes a client terminal 110 and a multi-functional printer (MFP) 120, and includes a print management server 140 and a data conversion server 150, which are connected to the client terminal 110 and the MFP 120 via a network 130. Here, the print management server 140 and the data conversion server 150 will sometimes be referred to as a print processing system or a server system together.

The network 130 is, for example, a local area network (LAN), a wide area network (WAN), a telephone line, or a dedicated digital line. Also, the network 130 is an asynchronous transfer mode (ATM), a frame relay line, a cable television line, a data broadcast radio line, or the like. Alternatively, the network 130 is a so-called communication network such as the Internet implemented by combining these.

The client terminal 110 and the MFP 120 are connected to the Internet via access points. The client terminal 110 may be an information processing apparatus, that is, an apparatus including a computer. The client terminal 110 includes a web browser and applications, and can transmit print data or print setting information to the print management server 140 via the network 130. Also, the client terminal 110 includes a message function 111. The message function 111 indicates a function capable of receiving messages such as mail, SMS, and chat application, but is not limited to mail, SMS, and chat application. Note that the client terminal 110 can be any terminal such as a smartphone, a tablet, or a general-purpose computer if it can be connected to the Internet. The MFP 120 is multi-functional equipment having a plurality of functions such as a scanner or a printer, and is an example of an image processing apparatus.

The print management server 140 provides functions of managing print data such as print data storage, print job creation, and print job transmission in accordance with communication with the client terminal 110 and the MFP 120.

The data conversion server 150 performs rendering processing of converting print data received from the print management server 140 into a data format printable by the MFP 120. More specifically, adjustment of the resolution of a document or an image, adjustment of the page layout or arrangement of the document, and setting of the output format of a printed product are performed, and converting print data is converted into a data format such as PDF, JPEG, or TIFF, which is printable by the MFP 120.

Note that the print management server 140 and the data conversion server 150 may be implemented by one server computer, or may be implemented by three or more server computers.

### Hardware Configuration

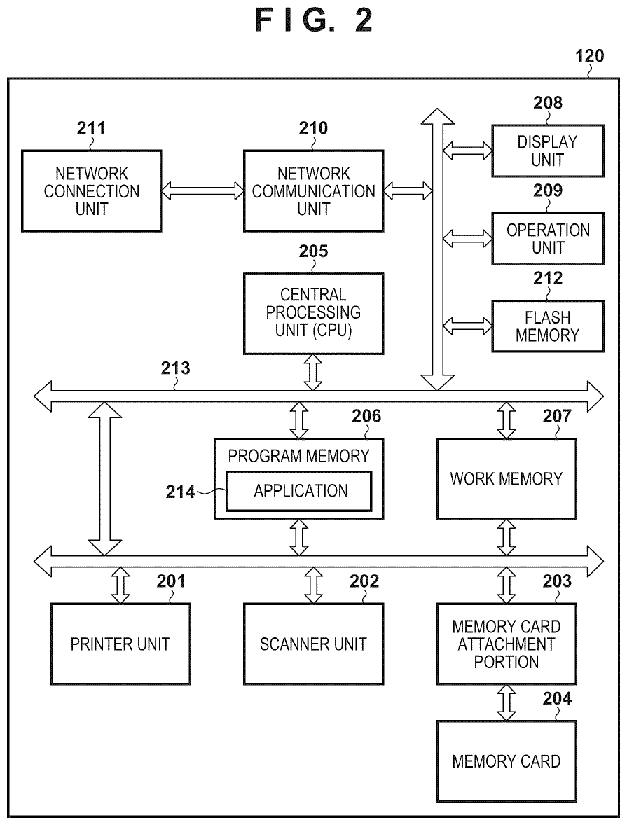

FIG. 2 is a block diagram showing the schematic configuration of the MFP 120 as an image processing apparatus. In the MFP 120, a print function is implemented by a printer unit 201, a scanner function is implemented by a scanner unit 202, and a storage function is implemented by a memory card attachment portion 203 and a memory card 204. The printer unit 201 prints image data received from the outside, image data stored in the memory card 204 on print paper, or the like using a printing method such as an inkjet method or an electrophotographic method. The printer unit 201 also manages ink information including a remaining ink amount and paper information including the number of loaded sheets.

The scanner unit 202 optically reads an original set on an original table (not shown), converts the data into electronic data, further converts it into image data of a designated file format, and transmits the image data to an external apparatus via a network or stores the image data in a storage area (not shown) of an HDD or the like. A copy service is implemented by transferring image data generated by reading an original placed on the original table by the scanner unit 202 to the printer unit 201 and causing the printer unit 201 to print the image data on print paper.

The memory card 204 attached to the memory card attachment portion 203 stores various kinds of file data. The file data can be read out from an external apparatus via a network and edited. It is also possible to store file data from the external apparatus in the memory card 204.

The MFP 120 further includes a CPU 205, a program memory 206, a work memory 207, a display unit 208, an operation unit 209, a network communication unit 210, a network connection unit 211, and a flash memory 212. The CPU 205 is a central processing unit configured to control units in the MFP 120. The program memory 206 is formed by a ROM or the like, and stores various kinds of program codes and an application 214 configured to communicate with a server apparatus. The application 214 also accesses the printer unit 201 and acquires information of consumable articles such as ink and paper. The work memory 207 is formed by a RAM or the like, and image data is temporarily stored or buffered in it at the time of execution of each service. The display unit 208 is formed by, for example, an LCD and displays various kinds of information. The operation unit 209 is formed by switches and the like used by a user to perform various kinds of input operations. The display unit 208 and the operation unit 209 may be implemented by a touch panel that integrates these. The network communication unit 210 connects the MFP 120 to the network and performs various kinds of communication. The network communication unit 210 can be connected to a network such as the Internet via the network connection unit 211. The network communication unit 210 supports a wired LAN or a wireless LAN. The network connection unit 211 when supporting a wired LAN is a connector configured to connect a cable of a wired LAN. The network connection unit 211 when supporting a wireless LAN is an antenna. The flash memory 212 is a nonvolatile memory configured to store image data or the like received by the network communication unit 210. The above-described units are connected to each other via a bus 213.

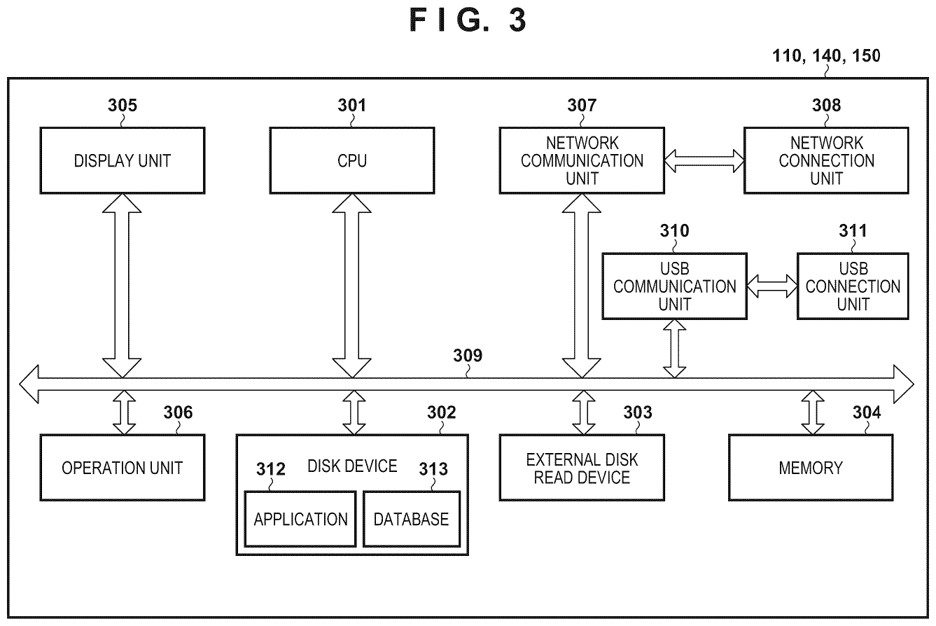

FIG. 3 is a block diagram showing the schematic configuration of the client terminal 110, the print management server 140, and the data conversion server 150.

A CPU 301 is a central processing unit configured to control the following units. A disk device 302 stores not only an application program 312 to be read out by the CPU 301, a database 313, and an OS but also various kinds of files. An external storage medium read device 303 is a device configured to read out information of files and the like stored in an external storage medium such as an SD card. A memory 304 is formed by a RAM or the like, and the CPU 301 temporarily stores or buffers data in it as needed. A display unit 305 is formed by, for example, an LCD and displays various kinds of information. An operation unit 306 is formed by a keyboard, a mouse, and the like used by a user to perform various kinds of input operations. A network communication unit 307 is connected to a network such as the Internet via a network connection unit 308 and performs various kinds of communication. The network communication unit 307 supports a wired LAN or a wireless LAN. The network connection unit 308 when supporting a wired LAN is a connector configured to connect a cable of a wired LAN. The network connection unit 308 when supporting a wireless LAN is an antenna. Note that the network connection unit 308 may support both a wired LAN and a wireless LAN. The USB communication unit 310 is connected to various kinds of peripheral devices via a USB connection unit 311 and performs various kinds of communication. The above-described units are connected to each other via a bus 309. The client terminal 110 in FIG. 3 separately shows the display unit 305 and the operation unit 306. However, the present invention is not limited to this, and a touch panel display that integrates the display unit and the operation unit may be used.

### Overall Processing Procedure

### Rendering of Print Data

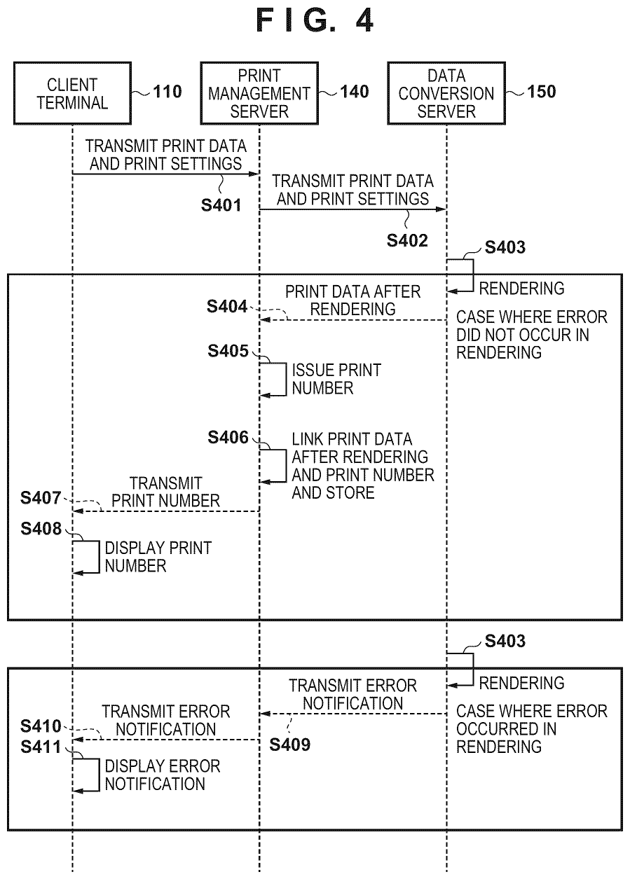

In this embodiment, processing after the client terminal 110 transmits print data to the print management server 140 in accordance with a user operation until the client terminal 110 displays a notification received from the print management server 140 on the display unit 305 of the terminal will be described. FIG. 4 is a sequence chart showing the processing. Note that an operation performed by each apparatus in FIG. 4 is implemented by the CPU of each apparatus executing a program loaded to the memory. The operation of the client terminal 110 may be, for example, the operation of a web browser executed on the client terminal 110.

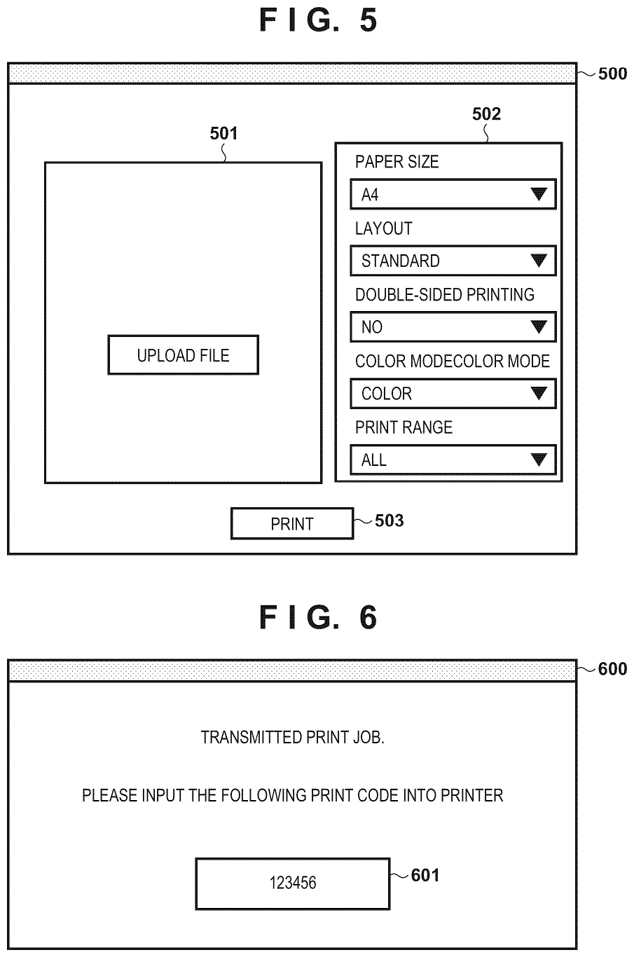

First, in S401, the client terminal 110 transmits print data and print settings that the user sets by operating the client terminal 110 to the print management server 140. FIG. 5 shows an example of a print setting screen displayed on the display unit 305 of the client terminal 110. Note that details of the processing will be described later. Next in S402, the print management server 140 transmits the print data and the print settings received from the client terminal 110 to the data conversion server 150. In S403, the data conversion server 150 performs rendering of the print data received from the print management server 140. Rendering here is processing of converting the print data into a data format printable by the MFP 120 based on the print settings received from the print management server 140. More specifically, based on the received print settings, adjustment of the resolution of a document or an image, adjustment of the page layout or arrangement of the document, and setting of the output format of a printed product are performed, and the print data is converted into a data format such as PDF, JPEG, or TIFF, which is printable by the MFP 120. At the time of rendering by the data conversion server 150, if the print data is corrupted, the print data is encrypted, or the format of the print data is not supported by a rendering engine to be used, an error may occur in rendering.

If no error occurs in the rendering by the data conversion server 150 in S403, in S404, the data conversion server 150 transmits the print data after rendering to the print management server 140. Print data after rendering indicates print data generated by the rendering processing. Next, in S405, the print management server 140 issues identification information, for example, a print number corresponding to the received print data. The print number here is a unique number linked with a print job to identify the job. In S406, the print management server 140 links the print data after rendering received from the data conversion server 150 with the print number issued in S405, and stores these as a print job in the database 313. After that, in S407, the print management server 140 transmits the issued print number to the client terminal 110. In S408, the client terminal 110 displays the print number received from the print management server 140 on the display unit 305 of the terminal. FIG. 6 shows a print number display screen on the client terminal. Note that details of the processing will be described later.

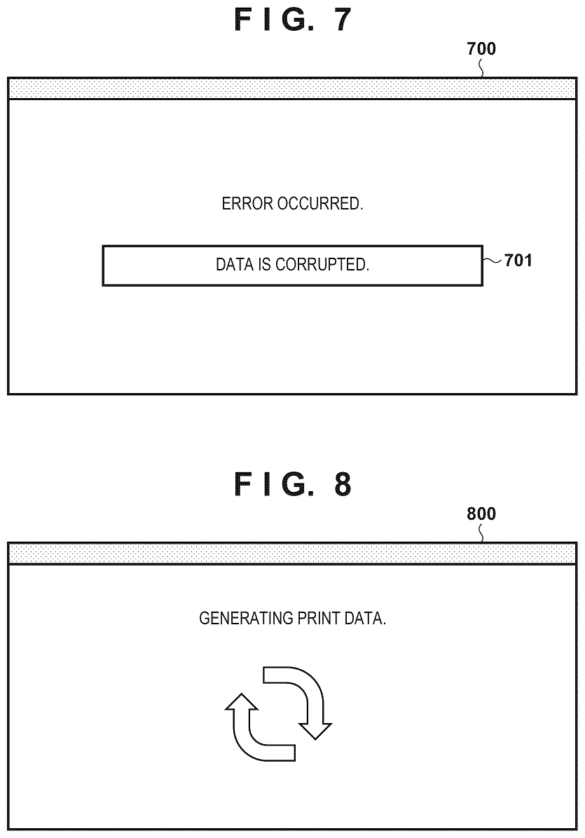

If an error occurs in the rendering by the data conversion server 150 in S403, in S409, the data conversion server 150 transmits an error notification to the print management server 140. Here, the contents of the error notification do not only simply notify the error occurrence, and the notification contents may be changed in accordance with the type of the error. In S410, the print management server 140 transmits the error notification received from the data conversion server 150 to the client terminal 110. In S411, the client terminal 110 displays the error notification received from the print management server 140 on the display unit 305 of the terminal. FIG. 7 shows an example of a print error screen displayed on the client terminal 110. Note that details of the processing will be described later.

FIG. 5 shows a print setting screen 500 on the client terminal 110. An upload area 501 is an area to upload a file, and a file can be uploaded using a button or drag-and-drop. A print setting 502 is a field to select print setting information. The print setting 502 includes the number of copies, a paper size, a layout, a double-sided printing setting, a print color setting, and a print range. Note that the print setting 502 is not limited to the number of copies, the paper size, the layout, the double-sided printing setting, the print color setting, and the print range. In addition, the print setting 502 implements a function of accepting an input via an input box or a selection box. When the user uploads a file in the upload area 501, edits the print settings in the print setting 502, and presses a print button 503, transmission of print data and print settings in S401 is executed. After that, during execution of rendering by the data conversion server 150, the client terminal 110 displays a screen shown in FIG. 8, which indicates that print data generation is progressing. Note that “during execution of rendering” may be time until the client terminal 110 receives the print number notification from the print management server 140 in S407 or the error notification in S411.

FIG. 6 shows a display screen of a print number in which the client terminal 110 displays the print number transmitted from the print management server 140 at the time of S407. A print number display screen 600 indicates the framework of the GUI of the print number display screen, and a display field 601 is the display field of the print number. When the print management server 140 executes print number transmission in S407, the screen shown in FIG. 6 is displayed on the display unit 305 of the client terminal 110.

FIG. 7 shows a display screen of an error notification transmitted from the print management server 140 at the time of error notification transmission in S410. An error notification display screen 700 indicates the framework of the GUI of the error notification display screen, and a display field 701 is the display field of error notification contents. The error notification contents may be changed in accordance with the type of the error, and the field may be blank if the error occurrence is simply notified.

FIG. 8 shows a print data generation screen 800 that the client terminal 110 displays during rendering by the data conversion server 150 in S403. If no error occurs in the rendering by the data conversion server 150, the screen changes to the print number display screen 600 in FIG. 6. If an error occurs in the rendering, the screen changes to the error notification display screen 700 in FIG. 7.

### Printing Procedure

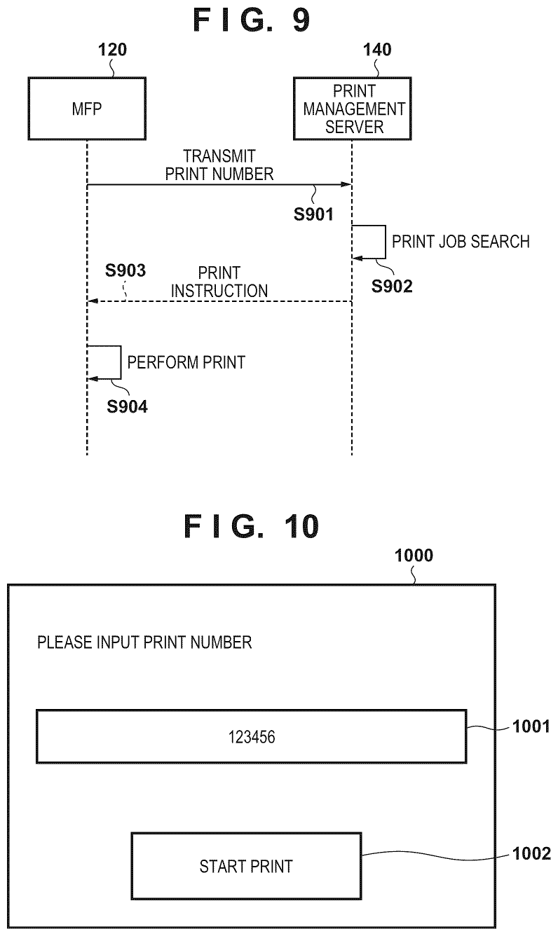

Next, FIG. 9 is a sequence chart showing processing until the MFP 120 transmits, to the print management server 140, a print number input by the user by operating the operation unit 209 of the MFP 120, and a print job held in the print management server 140 is printed by the MFP 120.

First, in S901, the MFP 120 transmits, to the print management server 140, a print number input by the user by operating the operation unit 209 of the MFP 120. The print number input by the user here is the print number displayed on the client terminal 110 in S408. FIG. 10 shows a print number input screen on the display unit 208 of the MFP 120. Note that details of the processing will be described later. Note that the print number may be input not only via the panel of the MFP 120 but also but also via the screen of a smartphone cooperating with the MFP 120. Next, in S902, the print management server 140 searches for the print job linked with the print number received from the MFP 120. In S903, the print management server 140 transmits a print instruction of the print job obtained by the search to the MFP 120. In S904, the MFP 120 receives the print instruction from the print management server 140 and executes printing. The print instruction that the MFP 120 receives includes the print job obtained by the search.

FIG. 10 shows the basic configuration of a screen used by the user to input the print number on the display unit 208 of the MFP 120. An input screen 1000 indicates the framework of the GUI on the MFP 120. When the user performs a predetermined operation, the input screen 1000 is displayed. When the user inputs the print number to a number input field 1001 and presses a print start button 1002, the print number is transmitted to the print management server 140.

In this embodiment, the client terminal can receive an error notification by the configuration and procedure as described above. The user can thus recognize an error occurrence before going to an image forming apparatus such as an MFP, and an occurrence of rework can be suppressed.

Note that in this embodiment, an example in which when print data received from the client terminal 110 is held in the print management server 140, the print data is linked with a print number, thereby executing the held print job has been described. On the other hand, print data received by the print management server 140 may be linked with the user and stored, user authentication may be performed in the MFP 120, and printing of the print job held in linkage with the authenticated user may be executed. In this case, since rendering of the print data is performed before the user authentication in the MFP 120, an error that occurs at the time of rendering can be confirmed on the client terminal 110 at the time of print data submission. “The time of print data submission” can be the time when the print data is transmitted from the client terminal 110 and rendered. This also applies to the following embodiments.

### Second Embodiment

In the first embodiment, after the client terminal 110 transmits, to the print management server 140, print data and print settings input by the user on the print setting screen shown in FIG. 5, the data conversion server 150 performs rendering processing. Until the rendering processing is completed, the user waits on the print data generation screen shown in FIG. 8. However, if the size of print data is large, rendering takes time, and the user may be caused to wait.

In this embodiment, after a client terminal 110 transmits print data and print settings to a print management server 140, the print management server 140 issues a print number and transmits it to the client terminal 110 before completion of the rendering. After that, if an error occurs in the rendering by a data conversion server 150, an error notification is transmitted to the client terminal 110 using a message notification method such as mail or chat, thereby reducing the wait time of the user.

### Overall Processing Procedure

### Rendering of Print Data

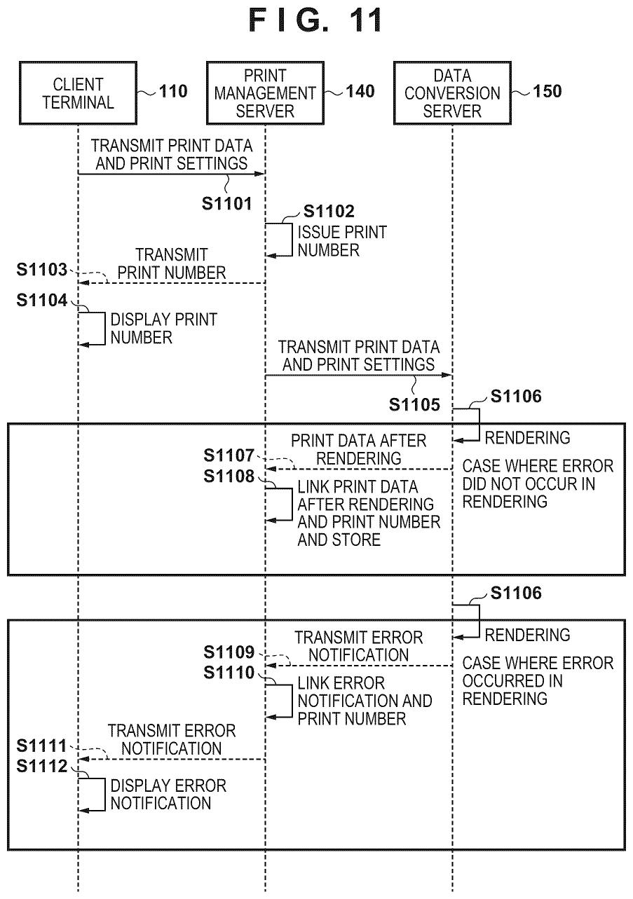

In this embodiment, processing after the client terminal 110 transmits print data to the print management server 140 in accordance with a user operation until the client terminal 110 displays a notification received from the print management server 140 on a display unit 305 of the terminal will be described. FIG. 11 is a sequence chart showing the processing. The configuration of each apparatus and the main execution constituent of processing are the same as in the first embodiment.

First, in S1101, the client terminal 110 transmits print data and print settings that the user sets by operating the client terminal 110 to the print management server 140. Next in S1102, the print management server 140 issues a print number. In S1103, the print management server 140 transmits the issued print number to the client terminal 110. After that, in S1104, the client terminal 110 displays the print number received from the print management server 140 on the display unit 305 of the terminal. FIG. 6 shows a print number display screen on the client terminal 110.

On the other hand, in S1105, the print management server 140 transmits the print job and print settings received from the client terminal 110 to the data conversion server 150. At this time, identification information may be added to the print data to be transmitted to the data conversion server 150 such that the print data after rendering and the issued print number can be linked. As the identification information, a print number may be used. In S1106, the data conversion server 150 performs rendering of the print data received from the print management server 140. If no error occurs in the rendering by the data conversion server 150 in S1106, in S1107, the data conversion server 150 transmits the print data after rendering to the print management server 140. At this time, the identification information received from the print management server 140 together with the print data may be added to the rendered print data. This can link the issued print number with the print data after rendering. Then, in S1108, the print management server 140 links the print data after rendering received from the data conversion server 150 with the print number issued in S1102, and stores these as a print job in a database 313.

If an error occurs in the rendering by the data conversion server 150 in S1106, in S1109, the data conversion server 150 transmits an error notification to the print management server 140. At this time, the identification information received from the print management server 140 together with the print data may be added to the error notification. This can link the issued print number with the error notification. Then, in S1110, the print management server 140 links the error notification received from the data conversion server 150 with the print number issued in S1102, and stores these in the database 313.

In S1111, the print management server 140 transmits the error notification received from the data conversion server 150 to the client terminal 110. At this time, the error notification may be transmitted to a message function 111 in the client terminal 110 using a message notification method such as mail or chat. The client terminal that is the error notification transmission destination may not be the client terminal 110 that is the print data transmission source. In that case, the address of the transmission destination may be set in, for example, the print management server 140 in advance on a user basis. Alternatively, the address may be transmitted from the client terminal 110 to the print management server 140 together with the print data. Note that the print number transmission destination in S1103 may be the same as the error notification destination.

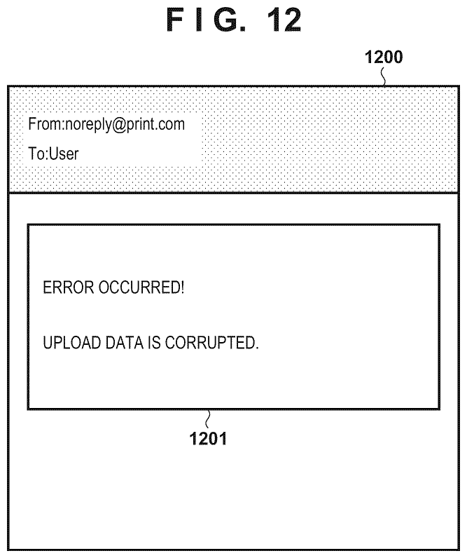

Next, in S1112, the message function 111 in the client terminal 110 displays the error notification received from the print management server 140 on the display unit 305 of the terminal. FIG. 12 shows an error notification screen displayed on the client terminal 110. If the error notification is transmitted to the message function 111 of the client terminal 110, the error notification screen may be displayed by the message function 111.

FIG. 12 shows the basic configuration of a screen that displays the contents of the error notification that the client terminal 110 receives from the print management server 140 in S1112. A screen 1200 indicates the framework of the GUI of the client terminal 110, and includes a message 1201 that notifies the contents of an error in rendering by the data conversion server 150. If the error notification is transmitted to the message function 111 of the client terminal 110, the screen 1200 may be displayed by the message function 111.

### Printing Procedure

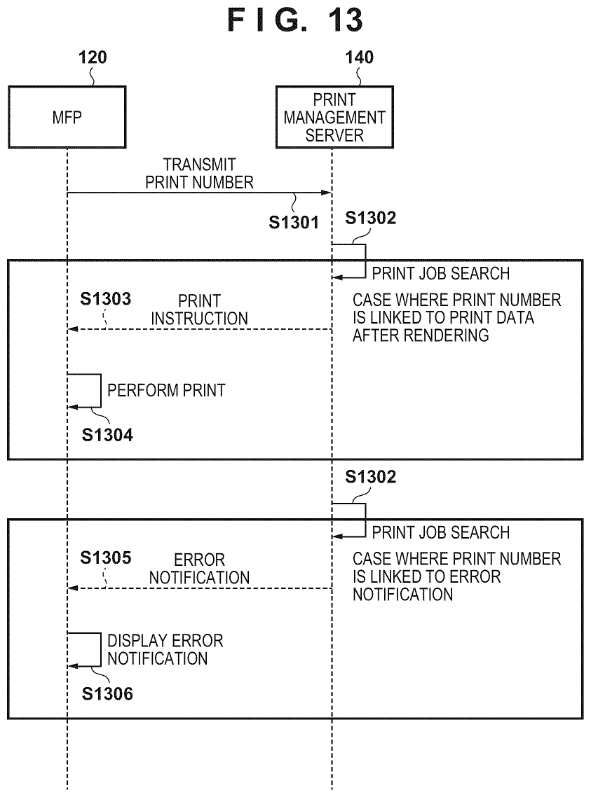

Processing until a print number input by the user by operating an operation unit 209 of an MFP 120 is transmitted to the print management server 140, and a print job held in the print management server 140 is printed by the MFP 120 will be described next. FIG. 13 shows a sequence chart of the processing.

First, in S1301, the MFP 120 transmits, to the print management server 140, a print number input by the user by operating the operation unit 209 of the MFP 120. The print number input by the user here is the print number displayed on the client terminal 110 in S1102. FIG. 10 shows a print number input screen on a display unit 208 of the MFP 120. Next, in S1302, the print management server 140 searches for the print number received from the MFP 120. If the searched print number is linked with the print data after rendering, in S1303, the print management server 140 transmits a print instruction of the print job to the MFP 120. The print instruction may include the print job. In S1304, the MFP 120 receives the print instruction from the print management server 140 and executes printing.

On the other hand, if the print management server 140 searches for the print number in S1302, and the searched print number is linked with an error notification, in S1305, the print management server 140 transmits the error notification linked with the print number to the MFP 120. Then, in S1306, the MFP 120 displays the error notification received from the print management server 140 on the display unit 208. The error notification screen here includes an error notification contents display field 701, as shown by the error notification screen on the client terminal 110 in FIG. 7. Note that the error notification contents may be changed in accordance with the type of the error, and the field may be blank if the error occurrence is simply notified.

As described above, when the print number is issued before rendering, the rendering wait time of the user can be shortened. Also, if an error occurs in rendering, an error notification is transmitted to the client terminal at the time of error occurrence by, for example, a message notification method such as mail or chat. Hence, the client terminal can notify the user of the error at an appropriate timing, and rework of print processing can be suppressed. In addition, even if the user operates the MFP and instructs printing before an error notification, if an error occurs, the error is notified by the MFP. Hence, the error notification to the user can reliably be performed.

### Third Embodiment

In the second embodiment, the print management server 140 issues a print number before the data conversion server 150 executes rendering on the print setting screen shown in FIG. 5, and if an error occurs, an error notification is transmitted to the client terminal 110. In addition, the error notification may be transmitted to the message function 111 of the client terminal using a message notification method such as mail or chat. This can reduce the rendering wait time.

As described above, there are various causes of an error in rendering. For example, there are a case where print data is corrupted and an error occurs at the time of rendering and a case here print data is encrypted and an error occurs because the print file cannot be opened. The timing at which the error occurs changes depending on the type of the error.

In this embodiment, the medium or timing to notify a user of an error is changed in accordance with the type of the error or the timing at which the error occurs, thereby reducing a load on the user in waiting. For example, when print data (for example, a file) is opened, an error may occur because the file type is not the processing target or the file is corrupted. Since such an error occurs at an early timing after a print instruction, the user is never made to wait for a long time even if the error notification is transmitted to the terminal used by the user to input the print instruction. Hence, an error that occurs in a short time from a print instruction can be notified to the terminal used by the user to input the print instruction. On the other hand, as for an error that occurs during rendering of print data, the occurrence time cannot be predicted. For this reason, if an error notification is transmitted to the terminal used to input the print instruction, the user needs to wait until the rendering is completed. When such an error is notified to, for example, the portable terminal of the user, the user need not wait on the terminal used to input the print instruction. This embodiment discloses the system and processing.

### Overall Processing Procedure

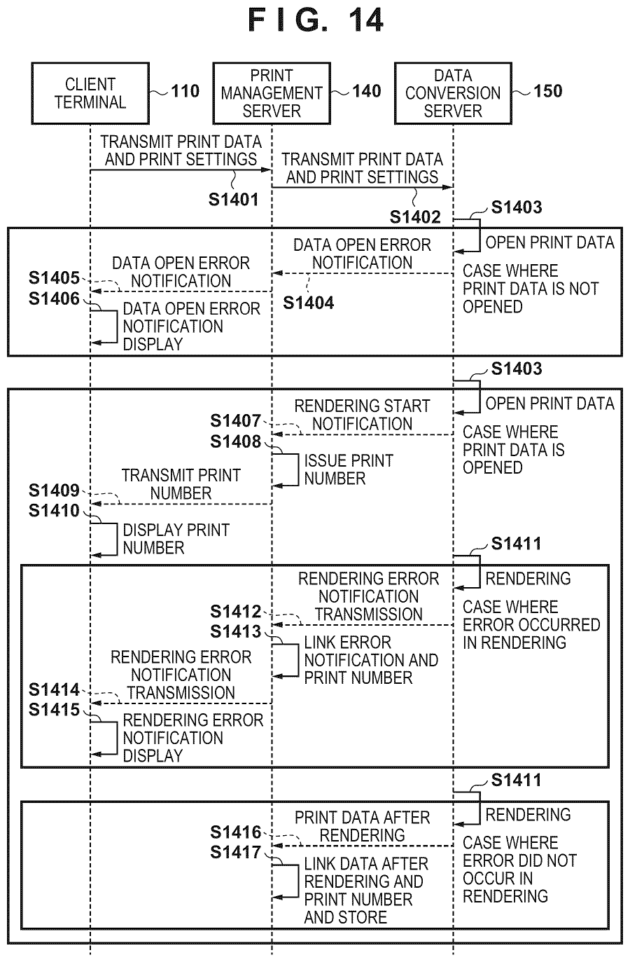

In this embodiment, processing after a client terminal 110 transmits print data to a print management server 140 in accordance with a user operation until the client terminal 110 displays a notification received from the print management server 140 on a display unit 305 of the terminal will be described. FIG. 14 is a sequence chart showing the processing.

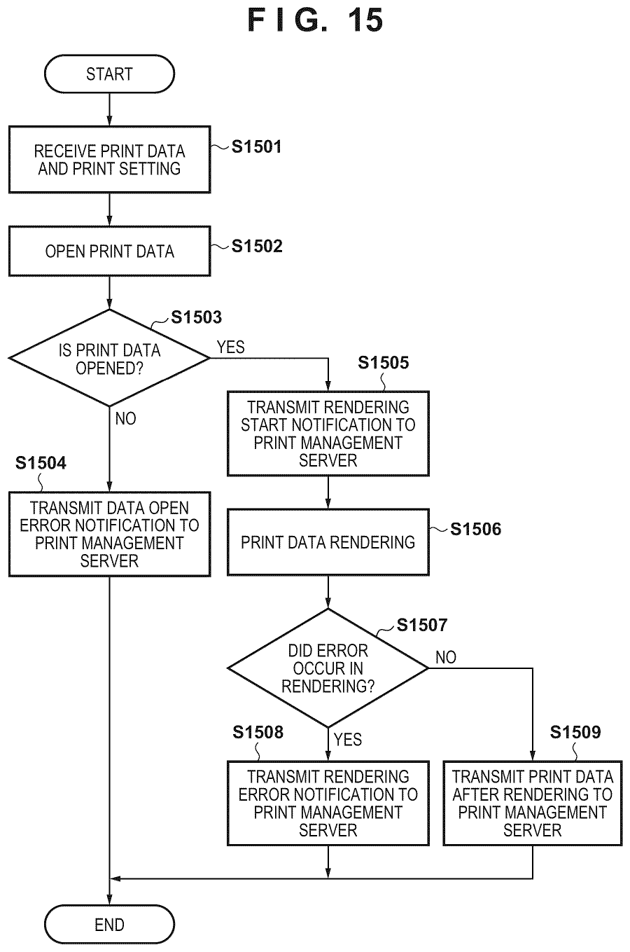

First, in S1401, the client terminal 110 transmits print data and print settings that the user sets by operating the client terminal 110 to the print management server 140. Next in S1402, the print management server 140 transmits the print data and the print settings received from the client terminal 110 to a data conversion server 150. In S1403, the data conversion server 150 opens the print data to execute rendering of the print data received from the print management server 140. The print data is, for example, a data file, and the data file (to be also referred to as a print data file) is opened here. Here, FIG. 15 shows processing after the data conversion server 150 receives the print data until it transmits a rendering result to the print management server 140. Note that details of the processing will be described later.

If the data conversion server 150 fails in opening the print data file in S1403, in S1404, the data conversion server 150 transmits a data open error notification to the print management server 140. In S1405, the print management server 140 transmits the data open error notification received from the data conversion server 150 to the client terminal 110. In S1406, the client terminal 110 displays the data open error notification received from the print management server 140 on the display unit 305 of the terminal. FIG. 7 shows an error notification screen on the client terminal 110.

On the other hand, if the data conversion server 150 succeeds in opening the print data file in S1403, in S1407, the data conversion server 150 transmits a rendering start notification to the print management server 140. Next, in S1408, the print management server 140 issues a print number. After that, in S1409, the print management server 140 transmits the issued print number to the client terminal 110. In S1410, the client terminal 110 displays the print number received from the print management server 140 on the display unit 305 of the terminal. FIG. 6 shows a print number display screen on the client terminal. Next to S1407, in S1411, the data conversion server 150 performs rendering of the print data.

If an error occurs in the rendering by the data conversion server 150 in S1411, in S1412, the data conversion server 150 transmits a rendering error notification to the print management server 140. Then, in S1413, the print management server 140 links the error notification received from the data conversion server 150 with the print number issued in S1408, and stores these in a database 313. In S1414, the print management server 140 transmits the rendering error notification received from the data conversion server 150 to the client terminal 110, for example, a message function 111 thereof. In S1415, the client terminal 110, for example, the message function 111 thereof displays the rendering error notification received from the print management server 140 on the display unit 305 of the terminal. FIG. 12 shows the rendering error notification displayed by the client terminal 110, for example, the message function 111 thereof.

On the other hand, if no error occurs in the rendering by the data conversion server 150 in S1411, in S1416, the data conversion server 150 transmits the print data after rendering to the print management server 140. In S1417, the print management server 140 links the print data after rendering received from the data conversion server 150 with the print number generated in S1408, and stores these as a print job in the database 313.

### Rendering Processing by Data Conversion Server

FIG. 15 is a flowchart of rendering performed by the data conversion server 150, and shows processing after the data conversion server 150 receives print data and print settings from the print management server 140 until it transmits a rendering processing result to the print management server 140.

First, in step S1501, print data and print settings are received from the print management server 140. Next, in step S1502, the print data is opened. In step S1503, it is determined whether the print data can be opened. If the print data cannot be opened, in step S1504, a data open error notification is transmitted to the print management server 140.

If the print data can be opened in step S1503, in step S1505, a print rendering start notification is transmitted to the print management server 140. After that, in step S1506, rendering of the print data is performed. In step S1507, it is determined whether an error occurs in the rendering of the print data. If an error occurs in the rendering, in step S1508, a rendering error notification is transmitted to the print management server 140. If no error occurs in the rendering of the print data in step S1507, in step S1509, print data after rendering is transmitted to the print management server 140.

As described above, the client terminal can notify the user of an error at an appropriate timing in accordance with the type of the error, and a load on the user in waiting can be reduced. Furthermore, like the first and second embodiments, rework of print processing can be suppressed. In addition, even if the user operates the MFP and instructs printing before an error notification, if an error occurs, the error is notified by the MFP. Hence, the error notification to the user can reliably be performed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-017428, filed Feb. 7, 2024 which is hereby incorporated by reference herein in its entirety.

What is claimed is:

1. A server system comprising:
at least one memory storing instructions; and
at least one processor that is in communication with the at least one memory and that, when executing the instructions, cooperates with the at least one memory to execute processing, the processing including:
controlling to render print data received from a terminal;
storing print data generated by the rendering; and
in a case where an error occurs in the rendering, notifying a terminal of the error.

2. The server system according to claim 1, wherein
in the notifying, the error is notified using a message function.

3. The server system according to claim 2, wherein
the terminal of a transmission source of the print data and the terminal of a notification destination of the error are different terminals.

4. The server system according to claim 3, wherein
in the notifying, if no error occurs in the rendering of the print data, identification information of the print data generated by the rendering is transmitted to the terminal of the notification destination of the error.

5. The server system according to claim 1, wherein
in the notifying, the error is notified to a transmission destination according to a timing at which the error has occurred.

6. The server system according to claim 5, wherein
in the notifying, an error that occurs when opening the print data for the rendering is notified to the terminal of a transmission source of the print data, and an error that occurs during the rendering of the print data is notified to a designated terminal.

7. The server system according to claim 1, wherein
the processing further includes
transmitting identification information of the print data generated by the rendering and stored to the terminal of a transmission source of the print data.

8. The server system according to claim 7, wherein
in the transmitting, in a case where the rendering of the print data succeeds, the identification information is transmitted.

9. The server system according to claim 7, wherein
in the transmitting, the identification information is transmitted in accordance with reception of the print data from the terminal.

10. The server system according to claim 1, wherein
the rendering of the print data is performed by a data conversion server.

11. The server system according to claim 1, wherein
the rendering of the print data is performed before a user performs, in an image forming apparatus, an operation for performing printing of the print data.

12. A non-transitory computer-readable storage medium storing a program configured to, when loaded in a computer of a server and executed, cause the computer to execute processing, the processing including:
rendering print data received from a terminal;
storing print data generated by the rendering; and
in a case where an error occurs in the rendering, notifying a terminal of the error.

13. An error notification method by a server system, comprising:
by the server system,
rendering print data received from a terminal;
storing print data generated by the rendering; and
in a case where an error occurs in the rendering, notifying a terminal of the error.
